(19) United States
(12) Patent Application Publication
(10) Pub. No.: US 2014/0045596 A1
(43) Pub. Date: Feb. 13, 2014

(54) METHODS AND SYSTEMS FOR DETERMINING THE LOCATION OF ONLINE GAMING CLIENTS

(71) Applicant: Lawrence Cameron Vaughan, Las Vegas, NV (US)

(72) Inventor: Lawrence Cameron Vaughan, Las Vegas, NV (US)

(21) Appl. No.: 13/569,128

(22) Filed: Aug. 7, 2012

(51) Int. Cl. A63F 13/12

(52) U.S. Cl. CPC A63F 13/12
USPC 463/42

(57) ABSTRACT

Methods, systems, and apparatus for determining the location of online gaming clients are provided. The method includes receiving an initial connection request, identifying at least one client characteristic, wherein the at least one client characteristic includes an internet protocol (IP) address and a client-provided location, analyzing, using the computer device, the at least one client characteristic to determine the location of the client, and allowing the client to use the computer device if the location is within a pre-determined area.

### CROSS-REFERENCE TO RELATED APPLICATIONS

The present application is related to the following application filed on the same day as this application, which is herein incorporated by reference in its entirety: METHODS AND SYSTEMS FOR UPDATING ONLINE GAMING CLIENTS by inventor Lawrence Cameron Vaughan having attorney docket number 31702-2.

### BACKGROUND OF THE INVENTION

This specification relates generally to online gaming, and more particularly, to methods and systems for determining the location of online gaming client.

Known gaming systems rely on physical gaming machines, tables, or other apparatus to operate. Traditionally, games like poker have been played in-person, using playing cards and money or money equivalents. In the context of a gaming establishment, such games can be monitored by the gaming establishment operator and regulated by gaming regulators. Recent developments in legal and regulatory schemes have, or will, enable gaming outside of traditional gaming establishments. For example, games like poker may be able to be played remotely, using the Internet and electronic representations of cards and money.

Known regulatory schemes require that the location of each player be verified to be within a pre-determined area, such as a state. The structure and operation of the Internet allow users to potentially connect to and play games from anywhere. For example, players may connect to online games using proxies, which may hide the true location of the player. Thus, independent verification of player location may be needed to satisfy regulators or to ensure a safe and fair playing environment. Accordingly, there is a need for methods and systems for determining the location of online gaming clients.

### BRIEF DESCRIPTION OF THE INVENTION

In one embodiment, a computer-implemented method for determining a location of a client using a computer device coupled to a memory device is provided. The method includes receiving an initial connection request, identifying at least one client characteristic, wherein the at least one client characteristic includes an internet protocol (IP) address and a client-provided location, analyzing, using the computer device, the at least one client characteristic to determine the location of the client, and allowing the client to use the computer device if the location is within a pre-determined area.

In another embodiment, a computer program product tangibly embodied in a non-transitory computer-readable storage device is provided. The storage device includes instructions, that when executed by a processor, cause the processor to receive an initial connection request, identify at least one client characteristic, wherein the at least one client characteristic includes an internet protocol (IP) address and a client-provided location, analyze, by the processor, the at least one client characteristic to determine the location of the client, and allow the client to use the computer device if the location is within a pre-determined area.

In yet another embodiment, a computer system including instructions stored on a non-transitory computer-readable medium is provided. The instructions are executable by at least one processor. The computer system includes a connection manager configured to receive an initial connection request. The computer system also includes a client location manager configured to identify at least one client characteristic, wherein the at least one client characteristic includes an internet protocol (IP) address and a client-provided location, analyze, by the computer system, the at least one client characteristic to determine the location of the client, and allow the client to use the computer system if the location is within a pre-determined area.

### BRIEF DESCRIPTION OF THE DRAWINGS

FIGS. 1-4 show exemplary embodiments of the methods and systems described herein.

FIG. 1 is a block diagram illustrating an example environment for online gaming.

FIG. 2 is a block diagram illustrating an exemplary gaming system for use with the environment in FIG. 1.

FIG. 3 is an exemplary method for determining the location of gaming clients shown in FIG. 1.

FIG. 4 is a block diagram illustrating a representative computing device that may be used to implement the systems of FIGS. 1 and 2.

Like reference numbers and designations in the various drawings indicate like elements.

### DETAILED DESCRIPTION OF THE INVENTION

Embodiments of the methods and systems described herein enable a gaming system to determine the location of connected client systems. The location is determined using multiple location techniques, which are each compared with a variety of data sources to increase confidence in the determined location. For example, using geolocation techniques, the client's IP address may be used to determine a location. The client may also provide a location in response to a request from the gaming system, such as an HTML5 geolocation request. The ports of the client are scanned to detect open ports for known remote desktop services. Remote desktop services may enable a player to be located remotely from the client. Additional client characteristics, such as identification data, are collected by the gaming system, such as a web browser version, an operating system version, and cookies. The identification data is used to identify clients and record successful locations associated with the client.

The following detailed description illustrates embodiments of the invention by way of example and not by way of limitation. It is contemplated that the invention has general application to online gaming, and it is contemplated that the invention may also be used for any online application or online interaction.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

The methods and systems described herein may be implemented using computer programming or engineering techniques including computer software, firmware, hardware or any combination or subset thereof, wherein the technical effects may include at least one of: a) receiving an initial connection request; b) identifying at least one client characteristic, wherein the at least one client characteristic includes an internet protocol (IP) address and a client-provided location; c) analyzing, using a computer device, the at least one client characteristic to determine the location of the client; and d) allowing the client to use the computer device if the location is within a pre-determined area.

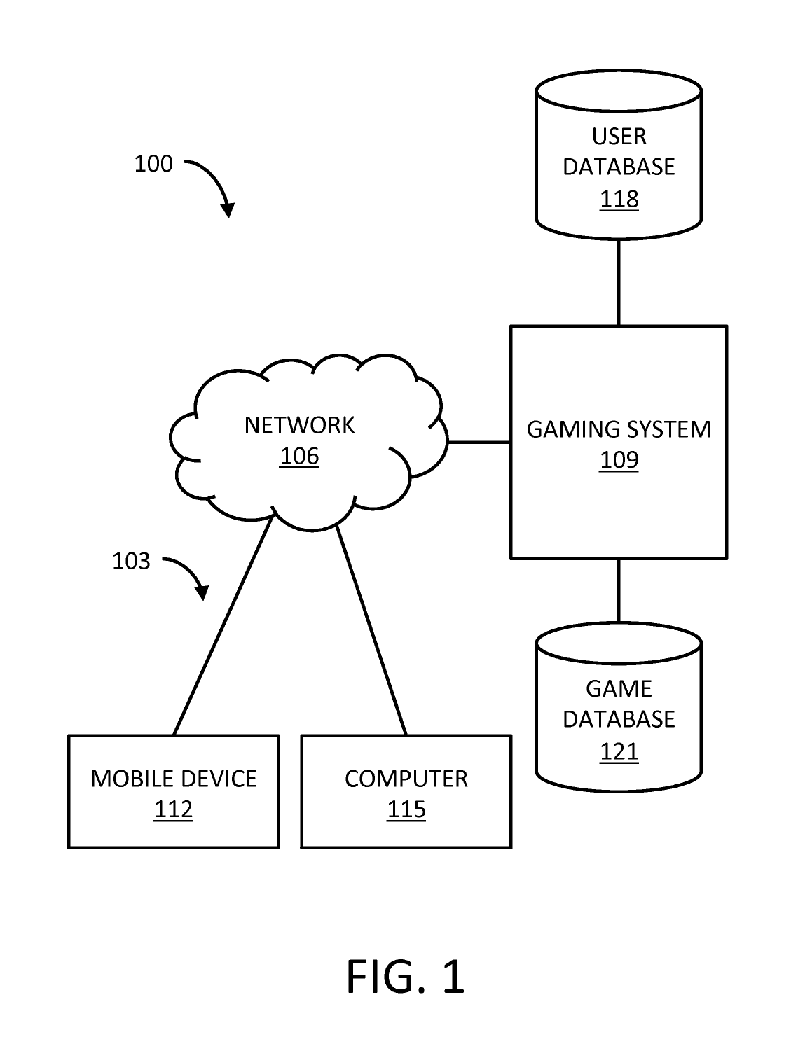

FIG. 1 is a diagram of an example environment 100 for online gaming. Environment 100 includes clients 103, or user devices, that are communicatively connected, through a network 106, with a gaming system 109. In practice, there may be more or fewer clients 103. In the exemplary embodiment, clients 103 include a mobile device 112 and a computer 115. Mobile device 112 may be a cell phone, a tablet, etc. Mobile device 112 and computer 115 may be similar, i.e., may have similar components, e.g., processors and memory, and similar functionality, and may be interchangeable. The clients 103, for example, can be used by users who access online resources, such as websites, webpages, games, and gaming content that are provided by gaming system 109. The clients 103 can include web browsers (e.g., by which users can access the resources). The network 106 can include any combination of the Internet, local area networks (LANs), wide area networks (WANs), and other networks.

In the exemplary embodiment, gaming system 109 is coupled to a user database 118 and a game database 121. User database 118 contains information about users of gaming system 109, such as user names, passwords, email addresses, user game history and statistics, financial information, etc. Game database 121 contains information about current and/or past games, including game state, game assets, game outcomes, users associated with each game, etc. Game assets are the components needed by client 103 to play the game, such as graphics, computer-executable code, code modules, etc.

During operation, client 103 initiates a gaming session by connecting to gaming system 109 via network 106. In some embodiments, the game is web-based and client 103 uses a web browser to send a web request to gaming system 109. Alternatively, client 103 may use game software to initiate the connection and otherwise communicate with gaming system 109. For example, a mobile app may be used to communicate with gaming system 109 via an application programming interface (API), web requests, remote procedure calls, etc. Regardless of how client 103 connects to gaming system 109, client 103 communicates with gaming system 109 and provides an interactive gaming interface for use by a user, or player.

Client 103 connects to gaming system 109 in order to authenticate a user, receive game components, receive game data, transmit game updates such as player moves, and otherwise participate in an online game. As the online game may be a multi-player game, more than one client 103 may be connected to gaming system 109 simultaneously such that each client 103 may participate in a game together. Gaming system 109 may be capable of providing more than one game type and more than one simultaneous game.

Once connected, gaming system 109 enables client 103 to play a game. Games may include table games such as poker and blackjack, board games, sports, and/or any other game. Games are played as one or more players receive a game state, make a move based on the game state, and receive an updated game state based on moves made. Game state may include a score of one or more players, player position, the next player to make a move, names and/or avatars/images of players, and/or any other data that represents the current state of a game. For example, in a game of poker, game state may include the names of players, where players are positioned around a simulated poker table, how much money a player has bet, how many cards a player has in hand, the size of the pot, etc. When transmitted by gaming system 109, game state may include the current state of the game or any changes since the last current state was transmitted (i.e., incremental updates).

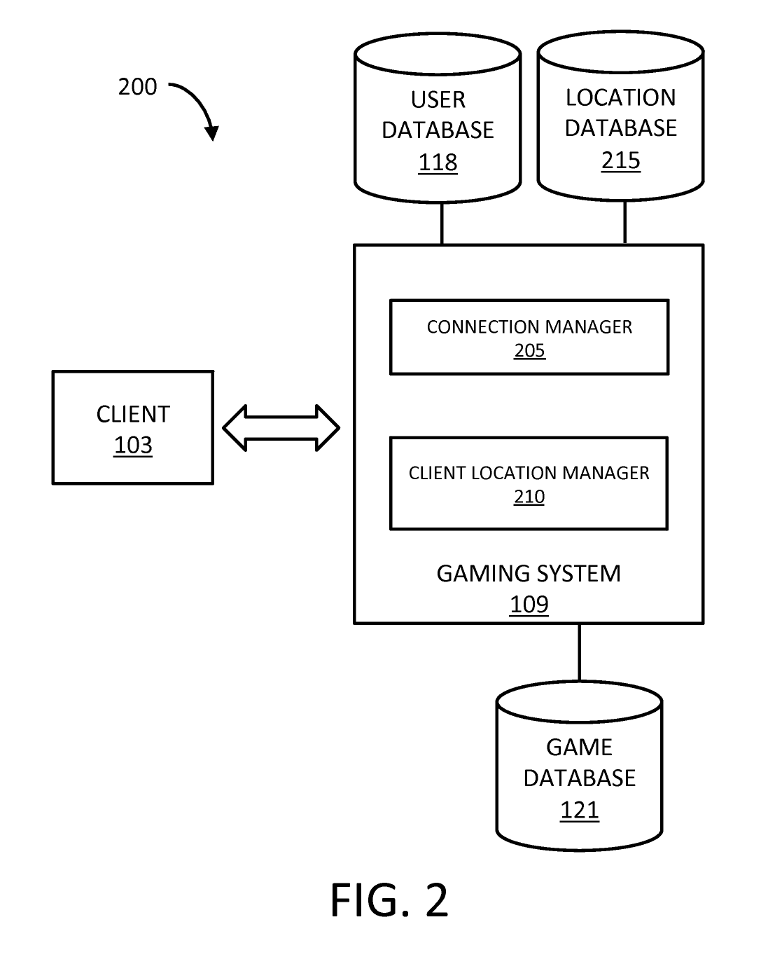

FIG. 2 is a block diagram of an exemplary gaming system 200 for use with environment 100 (shown in FIG. 1). In the exemplary embodiment, gaming system 109 includes a connection manager 205 and a client location manager 210. Gaming system 109 is configured to determine a user's physical location when connected to gaming system 109. In some embodiments, the user has provided a location to gaming system 109, in which case the gaming system 109 is configured to verify the provided location.

In the exemplary embodiment, a location database 215 is coupled to gaming system 109. Location database 215 contains associations between Internet Protocol (IP) addresses and coordinates (i.e., latitude and longitude). Location database 215 may be any known geolocation database or service that enables gaming system 109 to function as described herein. Location database 215 may be used to store locations previously determined by gaming system 109 together with an association to an IP address.

In the exemplary embodiment, connection manger 205 receives an initial connection from client 103 and establishes an initial connection. The initial connection may be used to authenticate a user, transmit an initial set of game assets to client 103, and transmit an initial game state to client 103. The initial set of game assets may include computer-executable code required to display a game, interact with the game, and/or communicate with gaming system 109.

Some example techniques for determining and verifying location are provided herein. The examples are illustrative only, and are not intended as an exhaustive collection of all possible location techniques. Client location manager 210 may use one or more of the exemplary techniques.

In the exemplary embodiment, client location manager 210 identifies one or more client characteristics, including a client IP, a client-reported location, a port scan result, and identification data from client software. Client location manager 210 determines the IP of client 103 using connection manager 205 and based on the initial connection. Client location manager 210 may request from client 103, e.g., using the HTML5 geolocation standard, the location of client 103. Client 103 may respond to the request with a client-reported location, which may be based on GPS, cell phone tower triangulation, WiFi network triangulation, and/or other suitable techniques.

Client location manager 210 identifies a list of open transmission control protocol (TCP) and/or user datagram protocol (UDP) ports on client 103 by conducting a port scan of client 103. A port scan is accomplished by attempted to connect to one or more ports on client 103 to determine if a connection can be made. The port scan results include which ports accepted connections and may include any data transmitted by client 103 upon making a connection. For example, if client 103 accepts a connection on port 25, commonly used for sending email, the port scan results may include the mail server greeting in association with port 25. Ports are scanned to determine if client 103 is accepting connections for remote desktop or remote control applications, such as VNC and Remote Desktop Connection, made available by the Microsoft Corporation of Redmond, Wash. The port scan results, including the list of open ports, is compared with a list of remote desktop ports. The list of remote desktop ports may be stored on gaming system 109. If client 103 is accessible remotely by such remote desktop applications, then the user of client 103 may not be in the same location as client 103.

Client location manager 210 collects identification data from the client software used to connect to gaming system 109, e.g., a web browser or gaming software. Identification data from client software may include screen resolution, operating system version, user ID, browser or software version, device ID, and/or cookies, among other things.

In the exemplary embodiment, client location manager 210 applies one or more tests to the identified client characteristics to determine if the client location is valid. The tests may be more or less reliable than each other, and so each test may be weighted in order to favor the more reliable tests. Each test may be given a weighted score, and each weighted score may be compared with a pre-determined threshold to determine whether a location is accurate. Tests may produce a pass/fail result, which may be weighted. As each approach for determining location may produce slightly different results, a user location may be acceptable if some or all of the determined locations are within a pre-determined radius, e.g., 5, 10, or 25 miles, or are within a pre-determined area, such as a state or county.

The tests may include comparing the client IP with a list of IPs for which location has been verified in the past, referred to as an IP success history. The IP success history may be stored in gaming system 109 and/or in location database 215. The tests may include determining a location, using location database 215, based on the client IP. The tests may include comparing the client IP to a list of known proxies. The list of known proxies include proxies that may be used to redirect data traffic between client 103 and gaming system 109 and conceal the true IP of client 103. The list of known proxies may be stored on gaming system 109. Gaming system 109 may detect possible proxies and add possible proxies to the list of known proxies. For example, gaming system 109 may detect that more than one user connects to gaming system 109 from a single IP address, whether concurrently or otherwise. The use of the single IP address by a plurality of users may indicate that a proxy operates at that IP address.

The tests may further include comparing the client IP to a history of IP usage. The history of IP usage includes a record of when each IP has been used, and in the test, may be used to determine a frequency of how often the client IP is used. Too frequent use of an IP may indicate improper use. The tests may include comparing the client-reported location with the IP-based location, determined using location database 215. The client-reported location and the IP-based location should be within a pre-determined radius, e.g., 5, 10, or 25 miles.

The tests may further include comparing the port scan results with a list of known remote desktop ports. The list of known remote desktop ports may be stored on gaming system 109, and may include VNC, RDP, and others. The tests may include determining how often or how recently a user ID or device ID was used at a confirmed location. More particularly, client 103 may be identified by one or more identification data, which are used to create a client profile, or client fingerprint. The tests may include determining how often or how recently client 103, having a client fingerprint, was determined to be in an acceptable location, based on the client fingerprint and a history of successes for client fingerprints.

The results of each test may be weighted and compared. If the pre-determined threshold is met, the location of client 103 is confirmed and the user is allowed to continue playing games using gaming system 109. However, if the pre-determined threshold is not met, the user of client 103 may be given an opportunity to verify the user's location through a secondary verification. In the exemplary embodiment, the secondary verification includes determining the location of a user's cell phone that is different than client 103. In other words, if the user is unable to verify the location of the user's computer, e.g., client 103 or computer 115, the user may use mobile device 112 (shown in FIG. 1).

The secondary verification includes sending a message to mobile device 112, such as an SMS, MMS, BlackBerry Messenger message, Apple iMessage message, or similar. The message includes a link, or URL, to a webpage provided by gaming system 109. The webpage includes an HTML5, or similar, location request. The response to the location request, which includes a location, is sent from mobile device 112 to client location manager 210. Mobile device 112 may determine the location using GPS, cell phone tower strengths, WiFi triangulation, and/or any other suitable location determination method. Client location manager 210 generates a code that is associated with the response to the location request. For example, the code could be stored with the response for later retrieval. Client location manager 210 transmits the code to mobile device 112, for example, as a second message or as part of the webpage provided by gaming system 109. The user may then enter the code on computer 115, i.e., client 103. Client location manager 210 receives the code from computer 115, and determines the location associated with the code. Client location manager 210 may then allow the user to continue playing if the location associated with the code approximately matches, e.g., is within a radius of, the user-provided location or if the location is within a pre-determined area. If the secondary verification fails, the user is not allowed to continue playing games using gaming system 109.

If the location of client 103 is verified or acceptable, using secondary verification or otherwise, a cookie may be placed on client 103. A location is accepted if it is within the pre-determined area wherein players may conduct remote gaming sessions. The cookie may contain a unique identifier that is associated with a player and/or client 103. The association may be stored in user database 118. On subsequent uses of gaming system 109, client 103 may provide the cookie as part of the identification data.

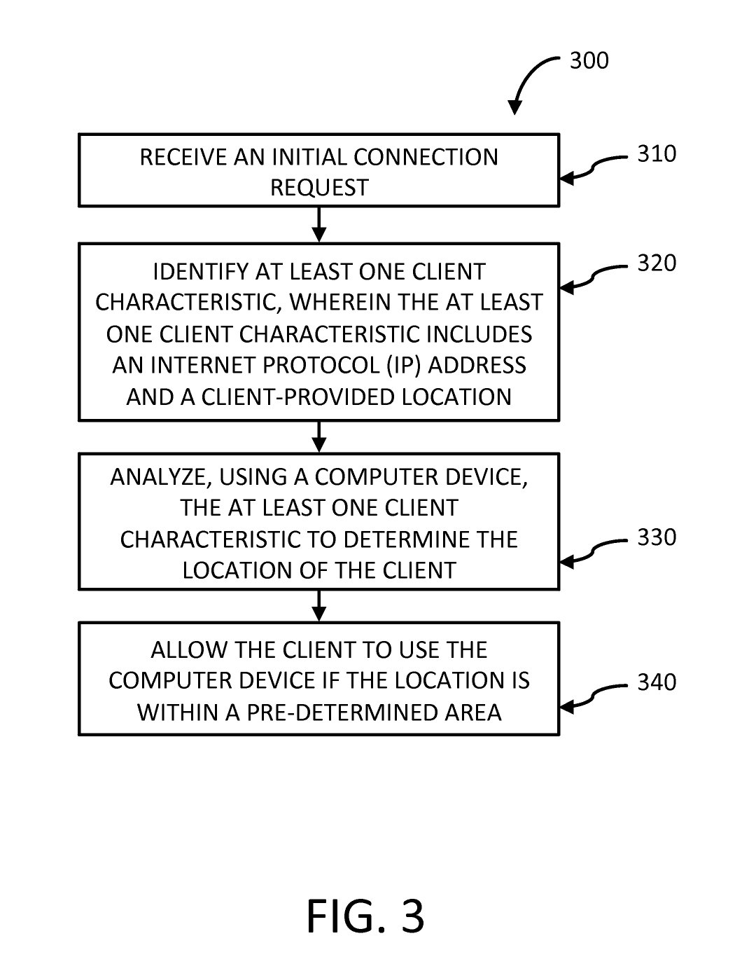

FIG. 3 is a flow chart of an exemplary method 300 for determining the location of a gaming client. Method 300 includes steps that can be implemented as instructions and executed by one or more processors in one or more computer systems. In some implementations, method 300 can be performed by client 103 and/or gaming system 109.

Initially, an initial connection request is received 310, e.g., by gaming system 109. The initial connection is established in response to the initial connection request. Using the initial connection, initial game assets and initial game state are transmitted 320, e.g., from gaming system 109 to client 103.

At least one client characteristic is identified 320. The at least one client characteristic may include an internet protocol address, a client-provided location, a port scan result, and identification data from the client. The at least one client characteristic is analyzed 330, e.g., by gaming system 109, to determine the location of the client. The analysis includes executing one or more tests, as described herein.

Method 300 includes allowing 340 the client to use the computer device if the location is within a pre-determined area. The user of client 103 may provide a location. The pre-determined area may be a circle with a radius originating at the user-provided location or may be a legal area such as a state or a county. The radius may be any length, such as 5, 10, or 25 miles.

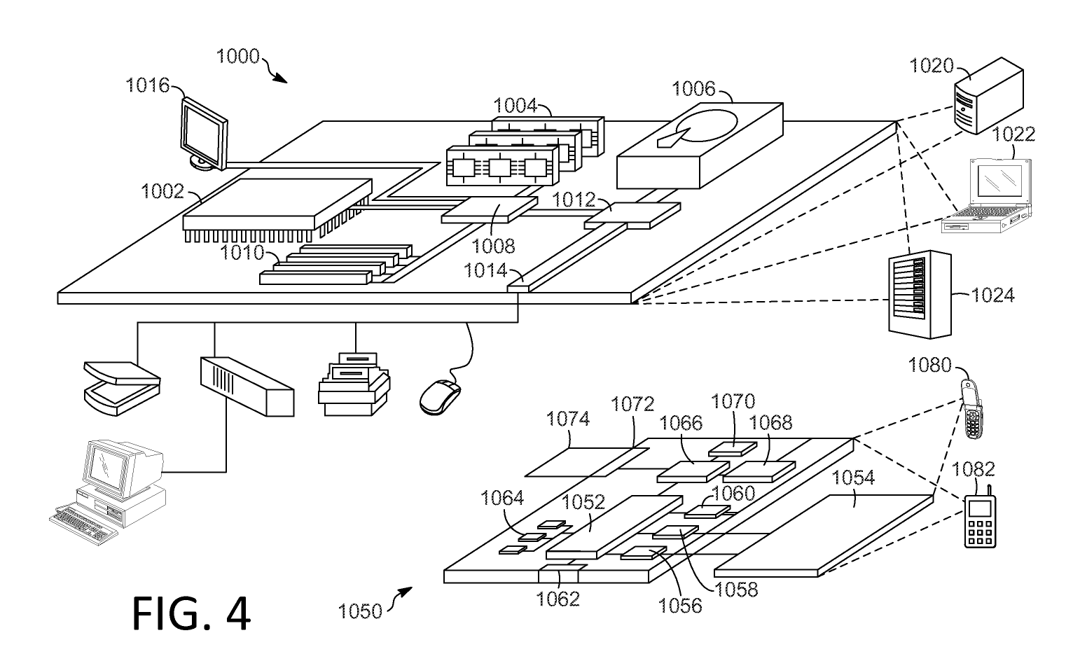

FIG. 4 is a block diagram showing example or representative computing devices and associated elements that may be used to implement the systems of FIGS. 1 and 2. FIG. 4 shows an example of a generic computing device 1000 and a generic mobile computing device 1050, which may be used with the techniques described here. Computing device 1000 is intended to represent various forms of digital computers, such as laptops, desktops, workstations, personal digital assistants, servers, blade servers, mainframes, and other appropriate computers. Computing device 1050 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 1000 includes a processor 1002, memory 1004, a storage device 1006, a high-speed interface or controller 1008 connecting to memory 1004 and high-speed expansion ports 1010, and a low-speed interface or controller 1012 connecting to low-speed bus 1014 and storage device 1006. Each of the components 1002, 1004, 1006, 1008, 1010, and 1012, are interconnected using various busses, and may be mounted on a common motherboard or in other manners as appropriate. The processor 1002 can process instructions for execution within the computing device 1000, including instructions stored in the memory 1004 or on the storage device 1006 to display graphical information for a GUI on an external input/output device, such as display 1016 coupled to high-speed controller 1008. In other implementations, multiple processors and/or multiple buses may be used, as appropriate, along with multiple memories and types of memory. Also, multiple computing devices 1000 may be connected, with each device providing portions of the necessary operations (e.g., as a server bank, a group of blade servers, or a multi-processor system).

The memory 1004 stores information within the computing device 1000. In one implementation, the memory 1004 is a volatile memory unit or units. In another implementation, the memory 1004 is a non-volatile memory unit or units. The memory 1004 may also be another form of computer-readable medium, such as a magnetic or optical disk.

The storage device 1006 is capable of providing mass storage for the computing device 1000. In one implementation, the storage device 1006 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1004, the storage device 1006, or memory on processor 1002.

The high-speed controller 1008 manages bandwidth-intensive operations for the computing device 1000, while the low-speed controller 1012 manages lower bandwidth-intensive operations. Such allocation of functions is exemplary only. In one implementation, the high-speed controller 1008 is coupled to memory 1004, display 1016 (e.g., through a graphics processor or accelerator), and to high-speed expansion ports 1010, which may accept various expansion cards (not shown). In the implementation, low-speed controller 1012 is coupled to storage device 1006 and low-speed bus 1014. The low-speed bus 1014, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1020, or multiple times in a group of such servers. It may also be implemented as part of a rack server system 1024. In addition, it may be implemented in a personal computer such as a laptop computer 1022. Alternatively, components from computing device 1000 may be combined with other components in a mobile device (not shown), such as device 1050. Each of such devices may contain one or more of computing device 1000, 1050, and an entire system may be made up of multiple computing devices 1000, 1050 communicating with each other.

Computing device 1050 includes a processor 1052, memory 1064, an input/output device such as a display 1054, a communication interface 1066, and a transceiver 1068, among other components. The device 1050 may also be provided with a storage device, such as a microdrive or other device, to provide additional storage. Each of the components 1050, 1052, 1064, 1054, 1066, and 1068, are interconnected using various buses, and several of the components may be mounted on a common motherboard or in other manners as appropriate.

The processor 1052 can execute instructions within the computing device 1050, including instructions stored in the memory 1064. The processor may be implemented as a chipset of chips that include separate and multiple analog and digital processors. The processor may provide, for example, for coordination of the other components of the device 1050, such as control of user interfaces, applications run by device 1050, and wireless communication by device 1050.

Processor 1052 may communicate with a user through control interface 1058 and display interface 1056 coupled to a display 1054. The display 1054 may be, for example, a TFT LCD (Thin-Film-Transistor Liquid Crystal Display) or an OLED (Organic Light Emitting Diode) display, or other appropriate display technology. The display interface 1056 may comprise appropriate circuitry for driving the display 1054 to present graphical and other information to a user. The control interface 1058 may receive commands from a user and convert them for submission to the processor 1052. In addition, an external interface 1062 may be provide in communication with processor 1052, so as to enable near area communication of device 1050 with other devices. External interface 1062 may provide, for example, for wired communication in some implementations, or for wireless communication in other implementations, and multiple interfaces may also be used.

The memory 1064 stores information within the computing device 1050. The memory 1064 can be implemented as one or more of a computer-readable medium or media, a volatile memory unit or units, or a non-volatile memory unit or units. Expansion memory 1074 may also be provided and connected to device 1050 through expansion interface 1072, which may include, for example, a SIMM (Single In Line Memory Module) card interface. Such expansion memory 1074 may provide extra storage space for device 1050, or may also store applications or other information for device 550. Specifically, expansion memory 1074 may include instructions to carry out or supplement the processes described above, and may include secure information also. Thus, for example, expansion memory 1074 may be provide as a security module for device 1050, and may be programmed with instructions that permit secure use of device 1050. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1064, expansion memory 1074, or memory on processor 1052, that may be received, for example, over transceiver 1068 or external interface 1062.

Device 1050 may communicate wirelessly through communication interface 1066, which may include digital signal processing circuitry where necessary. Communication interface 1066 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1068. In addition, short-range communication may occur, such as using a Bluetooth, Wife, or other such transceiver (not shown). In addition, GPS (Global Positioning system) receiver module 1070 may provide additional navigation- and location-related wireless data to device 1050, which may be used as appropriate by applications running on device 1050.

Device 1050 may also communicate audibly using audio codec 1060, which may receive spoken information from a user and convert it to usable digital information. Audio codec 1060 may likewise generate audible sound for a user, such as through a speaker, e.g., in a handset of device 1050. Such sound may include sound from voice telephone calls, may include recorded sound (e.g., voice messages, music files, etc.) and may also include sound generated by applications operating on device 1050.

The computing device 1050 may be implemented in a number of different forms, as shown in the figure. For example, it may be implemented as a cellular telephone 1080. It may also be implemented as part of a smart phone 1082, personal digital assistant, a computer tablet, or other similar mobile device.

Thus, various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system (e.g., computing device 1000 and/or 1050) that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In the example embodiment, computing devices 1000 and 1050 are configured to receive and/or retrieve electronic documents from various other computing devices connected to computing devices 1000 and 1050 through a communication network, and store these electronic documents within at least one of memory 1004, storage device 1006, and memory 1064. Computing devices 1000 and 1050 are further configured to manage and organize these electronic documents within at least one of memory 1004, storage device 1006, and memory 1064 using the techniques described herein.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included. For example, while online gaming has been referred to throughout, other applications of the above embodiments include online or web-based applications or other cloud services.

Also, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “identifying” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments of the invention may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the invention. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

While the disclosure has been described in terms of various specific embodiments, it will be recognized that the disclosure can be practiced with modification within the spirit and scope of the claims.

What is claimed is:

1. A computer-implemented method for determining a location of a client using a computer device coupled to a memory device, the method comprising:
receiving an initial connection request;
identifying at least one client characteristic, wherein the at least one client characteristic includes an internet protocol (IP) address and a client-provided location;
analyzing, using the computer device, the at least one client characteristic to determine the location of the client; and
allowing the client to use the computer device if the location is within a pre-determined area.

2. The computer-implemented method of claim 1, further comprising providing a secondary verification if the location is not within the pre-determined area, wherein the second verification includes requesting a location from a mobile device.

3. The computer-implemented method of claim 1, wherein identifying at least one client characteristic includes identifying at least one client characteristic, wherein the at least one client characteristic further includes port scan results and identification information.

4. The computer-implemented method of claim 3, wherein the identification information includes at least one of a browser version, an operating system version, a screen resolution, and a cookie.

5. The computer-implemented method of claim 3, wherein analyzing the at least one client characteristic comprises:
conducting a plurality of tests based on the at least one client characteristic, wherein each of the plurality of tests produces a test result;
assigning a weight to each test result; and
determining if a sum of the weighted test results meets a pre-determined threshold.

6. The computer-implemented method of claim 5, wherein the plurality of tests includes comparing the IP address with an IP success history.

7. The computer-implemented method of claim 5, wherein the plurality of tests includes comparing the IP address with a list of known proxies.

8. The computer-implemented method of claim 5, wherein the plurality of tests includes comparing the port scan results with a list of remote desktop ports.

9. A computer program product tangibly embodied in a non-transitory computer-readable storage device and comprising instructions that, when executed by a processor, cause the processor to:
receive an initial connection request;
identify at least one client characteristic, wherein the at least one client characteristic includes an internet protocol (IP) address and a client-provided location;
analyze, by the processor, the at least one client characteristic to determine the location of the client; and
allow the client to use the computer device if the location is within a pre-determined area.

10. The computer program product of claim 9, further comprising instructions that when executed cause the processor to provide a secondary verification if the location is not within the pre-determined area, wherein the second verification includes requesting a location from a mobile device.

11. The computer program product of claim 9, wherein identifying at least one client characteristic includes identifying at least one client characteristic, wherein the at least one client characteristic further includes port scan results and identification information.

12. The computer program product of claim 11, wherein the identification information includes at least one of a browser version, an operating system version, a screen resolution, and a cookie.

13. The computer program product of claim 11, further comprising instructions that when executed cause the processor to:
conduct a plurality of tests based on the at least one client characteristic, wherein each of the plurality of tests produces a test result;
assign a weight to each test result; and
determine if a sum of the weighted test results meets a pre-determined threshold.

14. The computer program product of claim 13, wherein the plurality of tests includes comparing the IP address with an IP success history.

15. The computer program product of claim 13, wherein the plurality of tests includes comparing the IP address with a list of known proxies.

16. The computer program product of claim 13, wherein the plurality of tests includes comparing the port scan results with a list of remote desktop ports.

17. A computer system including instructions stored on a non-transitory computer-readable medium and executable by at least one processor, the computer system comprising:
a connection manager configured to receive an initial connection request; and
a client location manager configured to:
identify at least one client characteristic, wherein the at least one client characteristic includes an internet protocol (IP) address and a client-provided location;
analyze, by the computer system, the at least one client characteristic to determine the location of the client; and
allowing the client to use the computer system if the location is within a pre-determined area.

18. The computer system of claim 17, wherein identifying at least one client characteristic includes identifying at least one client characteristic, wherein the at least one client characteristic further includes port scan results and identification information.

19. The computer system of claim 17, wherein the identification information includes at least one of a browser version, an operating system version, a screen resolution, and a cookie.

20. The computer system of claim 17, wherein the client location manager is configured to analyze the at least one client characteristic by:
conducting a plurality of tests based on the at least one client characteristic, wherein each of the plurality of tests produces a test result;
assigning a weight to each test result; and
determining if a sum of the weighted test results meets a pre-determined threshold.
